(19) United States
(12) Patent Application Publication
(10) Pub. No.: US 2024/0323664 A1
(43) Pub. Date: Sep. 26, 2024

(54) ELECTRONIC DEVICE AND METHOD OF OPERATION OF THEREOF

(71) Applicant: Samsung Electronics Co., Ltd., Suwon-si (KR)

(72) Inventors: Chungwoo PARK, Suwon-si (KR); Minhyung Kim, Suwon-si (KR); Boyoun Park, Suwon-si (KR); Soungkwan Kimn, Suwon-si (KR)

(73) Assignee: Samsung Electronics Co., Ltd., Suwon-si (KR)

(21) Appl. No.: 18/613,882

(22) Filed: Mar. 22, 2024

(30) Foreign Application Priority Data
Mar. 24, 2023 (KR) 10-2023-0039154
Jun. 2, 2023 (KR) 10-2023-0071850

(51) Int. Cl. H04W 4/90; H04W 4/38

(52) U.S. Cl. CPC H04W 4/90; H04W 4/38

(57) ABSTRACT

An electronic device includes an emergency call that receives an emergency call service request, a controller that operates the electronic device in one of a normal mode and an emergency control mode based on the emergency call service request, a temperature sensor that measures a temperature of a measurement target, and one or more memories that store temperature information about the temperature of the measurement target. The controller, when the electronic device is operated in the emergency control mode, performs a temperature control operation based on the temperature information.

### CROSS-REFERENCE TO RELATED APPLICATIONS

This application is based on and claims priority under 35 U.S.C. § 119 to Korean Patent Application No. 10-2023-0039154, filed on Mar. 24, 2023 and to Korean Patent Application No. 10-2023-0071850, filed on Jun. 2, 2023, in the Korean Intellectual Property Office, the disclosures of each of which being incorporated by reference herein in their entireties.

### BACKGROUND

The present disclosure relates to an electronic device, and more particularly, to an electronic device that operates by distinguishing between an emergency call (eCall) scenario and a telematics scenario other than the eCall.

With the development of information communication technology and vehicle electric technology, research is active on telematics that provides information services such as traffic situation guidance, emergency rescue information, and the Internet to vehicle drivers using vehicle location information and wireless communication networks.

Among the telematics functions, an eCall function that requests emergency rescue by transmitting an accident location and accident-related information to emergency rescue agencies either by the vehicle itself or manually in the event of a vehicle-related accident is a function that must be applied to vehicles.

### SUMMARY

It is an aspect to provide an electronic device that provides extended operating time in a high temperature environment by performing a temperature control operation by distinguishing emergency calls that require stable operation even in extreme environments for a short time and operations that require long hours of operation, and in particular, performs temperature control operations during operation in an emergency control mode based on emergency calls.

According to an aspect of one or more embodiments, there is provided electronic device comprising an emergency call controller configured to receive an emergency call service request; a controller configured to operate the electronic device in one of a normal mode and an emergency control mode based on the emergency call service request; a temperature sensor configured to measure a temperature of a measurement target; and at least one memory that stores temperature information about the temperature of the measurement target, wherein the controller is configured to, when the electronic device is operated in the emergency control mode, perform a temperature control operation based on the temperature information.

According to another aspect of one or more embodiments, there is provided a method of operating an electronic device that supports a telematics function for a vehicle, the method comprising receiving, by the electronic device, an emergency call service request; and operating the electronic device in an emergency control mode based on the emergency call service request, wherein the operating includes performing a temperature control operation while the electronic device operates in the emergency control mode.

According to yet another aspect of one or more embodiments, there is provided an electronic device comprising at least one processor; and at least one memory that stores instructions which, when accessed and executed by the at least one processor, cause the at least one processor to perform an operating method comprising receiving an emergency call service request; and operating the electronic device in an emergency control mode based on the emergency call service request, wherein the operating includes performing a temperature control operation while the electronic device operates in the emergency control mode.

### BRIEF DESCRIPTION OF THE DRAWINGS

Various embodiments will be more clearly understood from the following detailed description taken in conjunction with the accompanying drawings, in which:

FIG. 1 is a block diagram illustrating an electronic device according to an embodiment;

FIG. 2 is a diagram for explaining an emergency call (eCall) according to an embodiment;

FIG. 3 is a flowchart illustrating an emergency control mode operation of an electronic device, according to an embodiment;

FIG. 4 is a diagram illustrating an example of control modes according to an embodiment;

FIG. 5 is a diagram illustrating a normal mode and an emergency control mode according to an embodiment;

FIG. 6 is a flowchart illustrating the overall operation of an electronic device according to an embodiment;

FIG. 7 is a diagram illustrating an example of control of an electronic device according to an embodiment;

FIG. 8 is a diagram illustrating an example of control of an electronic device according to an embodiment;

FIG. 9 is a diagram illustrating an example of an electronic device according to an embodiment;

FIG. 10 is a diagram illustrating a telematics system according to an embodiment; and

FIG. 11 is a diagram illustrating a one-time programmable (OTP) memory according to an embodiment.

### DETAILED DESCRIPTION

Hereinafter, various embodiments are described in detail with reference to the accompanying drawings.

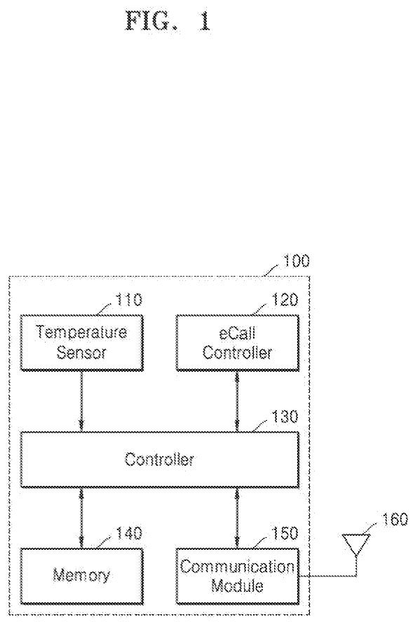

FIG. 1 is a block diagram illustrating an electronic device 100 according to an embodiment.

The electronic device 100 may be included in an electronic device included in a vehicle to perform a telematics function. For example, in some embodiments, the electronic device 100 may be provided in electronic devices such as a digital still camera, a digital video camera, a smartphone, a wearable device, an Internet of Things (IoT) device, a tablet personal computer (PC), a personal digital assistant (PDA), a portable multimedia player (PMP), a navigation device, etc. In some embodiments, the electronic device 100 may be included in electronic devices provided as a part, such as vehicles, furniture, manufacturing equipment, doors, various measuring devices, etc.

Referring to FIG. 1, the electronic device 100 may include a temperature sensor 110, an emergency call (eCall) controller 120, a controller 130, a memory 140, a communication module 150, and an antenna 160.

The temperature sensor 110 may measure a temperature of a measurement target. For example, in some embodiments, the measurement target may be the electronic device 100 or parts included in the electronic device 100. In some embodiments, the temperature sensor 110 may operate inside the electronic device 100. In some embodiments, the temperature sensor 110 may be separately installed outside the electronic device 100 to transmit measured data to the electronic device 100. The temperature sensor 110 may transmit periodically measured temperature data to the electronic device 100 or the controller 130 for monitoring. The temperature sensor 110 may, when the measured temperature exceeds a reference temperature, generate an event signal and inform the event signal to the electronic device 100 or the controller 130.

The emergency call (eCall) controller 120 may determine the severity of a traffic accident through interconnection with various sensing devices and a GPS receiver and automatically notify the vehicle accident to an emergency service according to the severity of the traffic accident. The emergency call controller 120 may automatically notify a vehicle accident by determining whether a vehicle accident has occurred and the severity of the vehicle accident based on information received from the sensing devices (e.g., information on objects outside the vehicle, amount of impact, etc.) and vehicle information (e.g., vehicle speed signal, vehicle location information, etc.) received from an in-vehicle device through CAN communication. When a collision occurs, the emergency call controller 120 may determine the type of accident target (vehicle, pedestrian, two-wheeled vehicle, etc.) and depending on the type of accident target, the degree of determining the severity of the vehicle accident may be set differently. That is, the emergency call controller 120 may generate an emergency call service request based on information received from a vehicle system.

In some embodiments, the emergency call controller 120 may receive an emergency call service request from a vehicle system.

In FIG. 1, the emergency call controller 120 is shown as being separately included in the electronic device 100 outside the controller 130 described below but embodiments are not limited thereto. In some embodiments, the emergency call controller 120 may be included in the controller 130 described below or may correspond to the controller 130 to be described below.

The controller 130 may be electrically connected to the temperature sensor 110, the emergency call (eCall) controller 120, the memory 140, and the communication module 150, etc. The controller 130 may electrically control each component and may be an electric circuit that executes software commands and/or instructions and may thus perform various data processing and calculations to be described below.

The controller 130 may generally control the operation of the electronic device 100 to provide a telematics function.

The controller 130 may control the electronic device 100 to operate in an emergency control mode or a normal mode based on the emergency call service request. For example, when the controller 130 receives an emergency call service request, the controller 130 may control the electronic device 100 may operate in an emergency control mode. When the controller 130 does not receive an emergency call service request, the controller 130 may control the electronic device to operate in a normal mode.

Here, operating in an emergency control mode may denote operating the electronic device 100 in a mode to provide first an emergency call service. For example, in the emergency control mode, the controller 130 may control the electronic device to prioritize providing an emergency call service over other services such as the telematics functions. Operating in the normal mode may mean normal operation to provide a telematics function. The normal mode and the emergency control mode are described in detail below.

The controller 130 may perform temperature control based on a temperature of the electronic device 100, a temperature of the controller 130, a temperature of at least one other hardware component of an electronic device connected to the electronic device 100, or a combination thereof. A method of controlling temperature by the controller 130 is described in detail below.

The memory 140 may store a variety of data used by at least one component of the electronic device 100 (e.g., the controller 130 or the temperature sensor 110). The data may include, for example, input data or output data for software and related instructions with the software. In some embodiments, the memory 140 may be implemented as volatile memory, such as DRAM or SRAM or non-volatile memory, such as ReRAM, PRAM, or NAND flash. In some embodiments, the memory 140 may be implemented as a memory card (e.g., MMC, eMMC, SD, micro SD) or the like. In some embodiments, the memory 140 may include one-time programmable (OTP) memory. In some embodiments, the memory 140 may include one or more memories. In some embodiments, the memory 140 may be implemented as a plurality of memories which store different types of data.

The communication module 150 may support establishment of a direct (e.g., wired) communication channel or wireless communication channel between the electronic device 100 and an external electronic device and communication through the established communication channel. The communication module 150 may include one or more communication processors that operate independently from the controller 130 (e.g., an application processor) and support direct (e.g., wired) communication or wireless communication. In some embodiments, the communication module 150 may include a wireless communication module (e.g., a cellular communication module, a short-range wireless communication module, or a global navigation satellite system (GNSS) communication module) or a wired communication module (e.g., a local area network (LAN) communication module or power line communication module). Among these communication modules, a corresponding communication module may communicate with an external electronic device through a first network including a short-range communication network, such as Bluetooth, WiFi direct, or infrared data association (IrDA), or a second network including a long-distance communication network, such as a cellular network, the Internet, or a computer network (e.g., LAN or a wide area network (WAN)). These various types of communication modules may be integrated into one component (e.g., a single chip) or implemented as a plurality of separate components (e.g., multiple chips). The wireless communication module may identify and authenticate the electronic device 100 within a communication network such as the first network or the second network using subscriber information (e.g., an international mobile subscriber identity (IMSI)) stored in a subscriber identification module.

The antenna 160 may transmit or receive signals or power to or from the outside (e.g., an external electronic device). In some embodiments, the antenna 160 may include one antenna including a radiator including a conductor or a conductive pattern formed on a substrate (e.g., a printed circuit board (PCB)). In some embodiments, the antenna 160 may include a plurality of antennas. In this case, at least one antenna suitable for a communication method used in a communication network, such as the first network or the second network, may be selected from the plurality of antennas by, for example, the communication module 150. A signal or power may be transmitted or received between the communication module 150 and an external electronic device through the selected at least one antenna. In some embodiments, other components (e.g., a radio frequency integrated circuit (RFIC)) may be additionally formed as a part of the antenna 160 in addition to the radiator.

At least some of the temperature sensor 110, the emergency call (eCall) controller 120, the controller 130, the memory 140, the communication module 150, and the antenna 160 may be connected to each other through a communication method (e.g., a bus, general purpose input and output (GPIO), serial peripheral interface (SPI), or mobile industry processor interface (MIPI)) between peripheral devices and may exchange signals (e.g., commands or data) with each other.

According to various embodiments, the operation time of the emergency control mode may be extended by performing a temperature control operation while an electronic device is operating in an emergency control mode. In other words, the operating time of the electronic device may be limited in a high-temperature environment. According to some embodiment, by performing a temperature control operation during operation in an emergency control mode, even in a high-temperature environment, it is possible to maximize the operating time of the emergency control mode, thereby maximizing the provision time of the emergency call service of the electronic device.

A method of performing a temperature control operation while an electronic device operates in an emergency control mode according to some embodiments will be described in detail below.

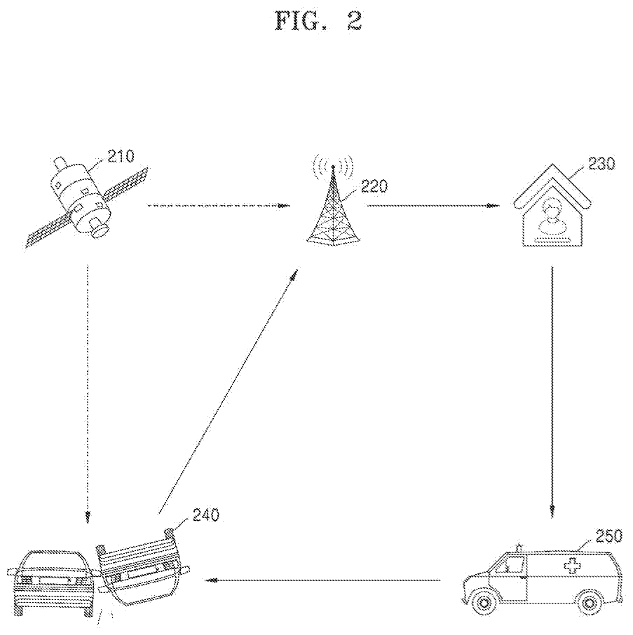

FIG. 2 is a diagram for explaining an emergency call (eCall) according to an embodiment.

Telematics may support smart home control, such as vehicle control and in-house device control, through a driver's smart terminal using a communication module and control module installed in a vehicle. In some embodiments, in addition to a normal communication function, the telematics may include an eCall function for requesting emergency rescue by transmitting an accident location and accident-related information to an emergency rescue agency by the vehicle itself or manually in the event of a vehicle-related accident.

Hereafter, the emergency call function may be referred to as an emergency call service. As shown in FIG. 2, when an accident occurs in a vehicle 240 equipped with an emergency call system, the emergency call system itself detects the accident and may transmit emergency call information that notifies a vehicle emergency call management system server 230 through a base station 220 that an accident requiring emergency rescue has occurred through a communication module installed in the vehicle.

Because the vehicle 240 equipped with the emergency call system receives location information from a GPS satellite 210, the received vehicle location information is also transmitted via the base station 220 to the vehicle emergency call management system server 230.

The vehicle emergency call management system server 230 requests an emergency call processing department to dispatch an accident response team 250 to the location of the vehicle 240. As an example, the vehicle 240 equipped with the emergency call system may perform an emergency call to an emergency rescue agency when an accident such as a collision between vehicles or a vehicle rollover occurs.

Data, such as the location of the accident, vehicle type, driving direction, automatic/manual reporting, fuel type, and whether seatbelts are worn to emergency responders in the vicinity of the accident location, may be automatically sent to emergency rescue agencies near the place where an accident has occurred. The telematics uses a multi-input multi-output (MIMO) antenna structure including at least one main antenna and an auxiliary antenna to improve data communication performance.

The emergency call system is also configured to perform an emergency call by selecting one of the main antenna and the auxiliary antenna according to a vehicle state in order to ensure a smooth operation of the emergency call function, even in the case of major vehicle damage such as vehicle overturn. Because a frequency domain used in telematics may be different from a frequency domain used in an emergency call, the antenna for telematics may be different from the antenna for an emergency call system.

In the case of an emergency call, the emergency call system must operate in all temperature environments including both a low temperature environment and a high temperature environment, and in particular, it is essential that the emergency call system operates even in hot weather such as summer in a desert.

For example, the emergency call operation must be performed for a certain period of time, even in an environment where the ambient temperature is 95 degrees. That is, the operating time of the electronic device may be limited in a high-temperature environment. According to an embodiment, by performing a temperature control operation during operation in an emergency control mode, even in a high-temperature environment, it is possible to maximize the operating time of the emergency control mode, thereby maximizing the provision time of the emergency call service of the electronic device.

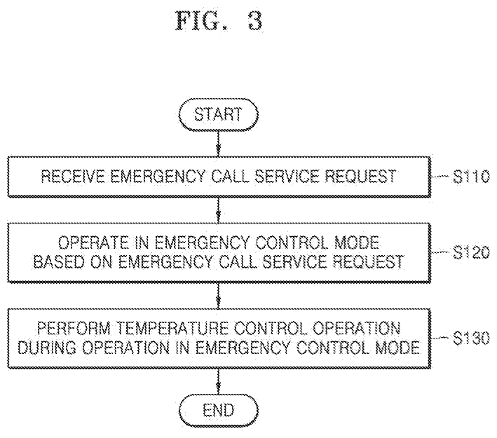

FIG. 3 is a flowchart illustrating an emergency control mode operation of an electronic device according to an exemplary embodiment.

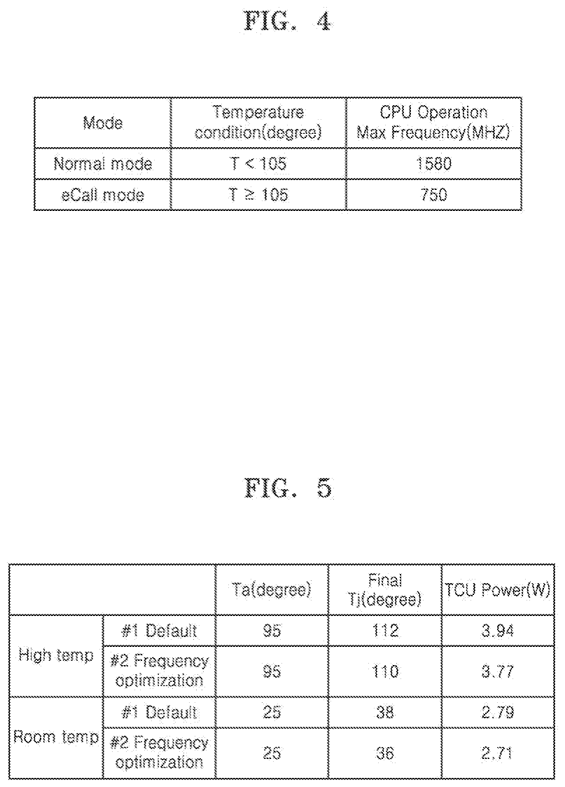

FIG. 4 is a diagram illustrating an example of control modes according to an embodiment. FIG. 5 is a diagram illustrating a normal mode and an emergency control mode according to an embodiment. The electronic device of FIG. 3 may correspond to the electronic device 100 of FIG. 1. The electronic device may operate in an emergency control mode when an emergency call service request occurs.

Operations performed by the electronic device in an emergency control mode may have higher priority than other operations of the electronic device. For example, operations performed by the electronic device in the emergency control mode may have a higher priority than operations performed by the electronic device outside the emergency control mode.

That is, the emergency control mode may refer to a mode in which the electronic device prioritizes the emergency call service without being disturbed by anything other than the emergency call service when performing the emergency call service.

The operations performed by the electronic device in the emergency control mode may include, for example, emergency call operations related to emergency call service and temperature control operations.

Referring to FIG. 3, in operation S110, the electronic device may receive an emergency call service request.

In an embodiment, a vehicle may include an electronic device and a vehicle system, and the electronic device may receive an emergency call service request from the vehicle system.

For example, the electronic device may receive an emergency call service request from a controller (e.g., a microcontroller unit (MCU)) of the vehicle system. Here, for example, the electronic device may include the emergency call system described with reference to FIG. 2, and the electronic device may support a vehicle telematics function. In an embodiment, the electronic device may generate an emergency call service request by determining whether a vehicle accident has occurred and the severity of the vehicle accident based on information received from a sensing device (e.g., object information outside the vehicle, impact amount, etc.) and vehicle information received from an in-vehicle device through controller area network (CAN) communication (e.g., vehicle speed signal, vehicle location information, etc.).

When a collision occurs, the electronic device may determine the type of accident target (vehicle, pedestrian, two-wheeled vehicle, etc.), and depending on the type of accident target, the degree of determining the severity of the vehicle accident may be set differently.

Referring to FIG. 3, in operation S120, the electronic device may operate in an emergency control mode based on the emergency call service request.

In an embodiment, the electronic device may perform an emergency call service in an emergency control mode based on the emergency call service request.

That is, the electronic device may first perform an emergency call service operation even if there is a request for data communication other than an emergency call. For example, the electronic device may perform an emergency call service operation with priority over the request for data communication other than the emergency call. In an embodiment, the electronic device may perform an emergency call operation for a predetermined time in the emergency control mode.

When the electronic device operates in the emergency control mode, the electronic device may store information including a number of times a first reference temperature is exceeded and may store information including a corresponding temperature of the measurement target when the first reference temperature is exceeded. Storing the number of times and the corresponding temperature may allow the electronic device to monitor the temperature of the electronic device and/or the components of the electronic device.

The electronic device may store in a memory and manage information including the number of times the monitored first reference temperature is exceeded and the corresponding temperature of the measurement target when the temperature is exceeded. For example, the electronic device may store information including the number of times the monitored first reference temperature is exceeded and the corresponding temperature of the measurement target when the temperature is exceeded in a non-volatile memory such as an OTP built in a modem or a NOR/NAND flash memory. In some embodiments, the electronic device may include the temperature sensor for measuring the temperature of the measurement target, and the electronic device may store the temperature of the measurement target when the temperature of the measurement target is equal to or greater than the first reference temperature.

In some embodiments, the measurement target may be, for example, a semiconductor chip or an integrated circuit included in an electronic device and performing a specific operation. In some embodiments, the first reference temperature may be, for example, a maximum value among guaranteed temperatures that guarantee the lifespan of the semiconductor chip. In some embodiments, the electronic device may periodically generate information about the temperature of the measurement target using the temperature sensor.

In some embodiments, the electronic device may store information including the number of times the temperature of the measurement target exceeds the first reference temperature and the corresponding temperature of the measurement target when the temperature exceeds the first reference temperature, based on periodically generated information about the temperature of the measurement target.

In an embodiment, the electronic device, based on the information about the temperature of the measurement target generated in a cycle of 1 second, information including the number of times the temperature of the measurement target exceeds the first reference temperature and the corresponding temperature of the measurement target when the temperature exceeds the first reference temperature may be stored in a first memory included inside the controller and a second memory mounted outside the controller, respectively.

In an embodiment, the first memory may be an OTP memory and the second memory may be a multiMediaCard (MMC) storage.

Referring to FIG. 3, in operation S130, the electronic device may perform a temperature control operation during operation in an emergency control mode.

In some embodiments, the electronic device may perform the temperature control operation during operation in the emergency control mode based on temperature information.

In an embodiment, the electronic device may include the temperature sensor to measure the temperature of the measurement target, and when the temperature of the measurement target is equal to or greater than a second reference temperature, the electronic device may perform a temperature control operation during operation in an emergency control mode.

In some embodiments, the second reference temperature may be, for example, the first reference temperature described above or may be a preset temperature that guarantees the lifespan of a semiconductor chip. In some embodiments, the measurement target may be, for example, a semiconductor chip or an integrated circuit that is included in an electronic device and that performs a specific operation. In an embodiment, the electronic device may periodically measure the temperature of an integrated circuit included in the electronic device while operating in the emergency control mode and may monitor the measured temperature or control the operation of the integrated circuit according to the temperature.

For example, the electronic device may monitor the temperature of the controller, the communication module, or other components included in the electronic device by using a temperature measurement value input from the temperature sensor while operating in an emergency control mode. In some embodiments, the electronic device may determine whether the temperature measured during operation in the emergency control mode is equal to or greater than the second reference temperature.

In some embodiments, when the measured temperature is equal to or greater than the second reference temperature, the electronic device may perform a temperature control operation during operation in an emergency control mode. In some embodiments, the electronic device may perform a temperature control operation during operation in an emergency control mode regardless of the temperature of the measurement target. In some embodiments, the temperature control operation may include a throttling operation in which the electronic device operates by limiting the performance of the electronic device, even when the temperature of the integrated circuit included in the electronic device exceeds a threshold temperature, or when the temperature causes a reset operation for resetting the included integrated circuit.

When the electronic device is in the throttling operation, the electronic device may be referred to as operating in a limiting control mode. In an embodiment, the temperature control operation performed by the electronic device may be an operation of controlling the temperature of the electronic device by operating in a limiting control mode that limits the operation of the electronic device as compared to normal operation of the electronic control device.

That is, the electronic device may perform a temperature control operation by operating in the limiting control mode while operating in an emergency control mode. In an embodiment, the electronic device may limit the performance of one or more components (e.g., one or more of the temperature sensor 110, the emergency call (eCall) controller 120, the controller 130, the memory 140, the communication module 150, and the antenna 160) included in the electronic device while operating in an emergency control mode.

For example, the electronic device may reduce a voltage or current supplied to one or more components (e.g., one or more of the temperature sensor 110, the emergency call (eCall) controller 120, the controller 130, the memory 140, the communication module 150, and the antenna 160) of the electronic device or reduce an operating frequency of a processor included in the electronic device, to limit performance while operating in an emergency control mode. In an embodiment, the electronic device may operate in a limiting control mode while operating in an emergency control mode by reducing the frequency of accessing a memory by the controller included in the electronic device. For example, the memory may store data related to a specific operation such that the data related to the specific operation is used by a controller included in the electronic device to perform the specific operation.

In an embodiment, the electronic device may operate in the limiting control mode while operating in an emergency control mode by reducing a maximum operating frequency of the controller included in the electronic device.

Referring to FIG. 4, it may be seen that the maximum operating frequency of the controller (e.g., a central processing unit (CPU)) included in the electronic device is shown according to the operating mode of the electronic device.

The normal mode may denote a state in which the electronic device normally operates, where the normal mode is a mode other than an emergency control mode. For example, the electronic device may operate in the normal mode when the temperature of the measurement target is less than the first reference temperature.

In an embodiment illustrated in FIG. 4, the first reference temperature may be 105 degrees. In some embodiments, the electronic device may operate in the normal mode by setting the maximum operating frequency of the controller (e.g., a CPU) to 1580 MHZ. In some embodiments, the electronic device may operate in an emergency control mode when the temperature of the measurement target is equal to or greater than the first reference temperature.

In some embodiments, the first reference temperature may be 105 degrees. In some embodiments, the electronic device may operate in an emergency control mode by setting the maximum operating frequency of the controller (e.g., a CPU) to 750 MHZ. That is, the electronic device may reduce power consumed by the semiconductor chip or integrated circuit in an emergency control mode by limiting the maximum operating frequency of the controller (e.g., a CPU) to be less in the emergency control mode than in the normal mode. Thus, even in the emergency control mode, there is an effect of reducing the temperature of a semiconductor chip or integrated circuit.

FIG. 5 is a diagram illustrating a normal mode and an emergency control mode according to an embodiment.

Referring to FIG. 5, it is shown that, according to cases when the temperature Ta of a surrounding environment is a high temperature (e.g., 95 degrees) and a normal temperature (e.g., 25 degrees), the final temperature (Tj) and power consumption of a controller performing an emergency call service are obtained by controlling the maximum operating frequency of the controller included in the electronic device.

In some embodiments, the controller may be a telematics control unit (TCU). Furthermore, the embodiment illustrated in FIG. 5 is described by assuming that when the temperature Ta of the surrounding environment is a high temperature (e.g., 95 degrees), the electronic device operates in an emergency control mode, and when the temperature Ta of the surrounding environment is a normal temperature (e.g., 25 degrees), the electronic device operates in a normal mode. For example, in some embodiments, the normal temperature may be a room temperature. In an embodiment, the electronic device may operate in a limiting control mode that reduces the maximum operating frequency of the controller in both the normal mode and the emergency control mode.

FIG. 5 illustrates that, in an embodiment, the non-limiting control mode is shown as ‘#1 Default’, and the limiting control mode is shown as ‘#2 Frequency optimization’. Referring to FIG. 5, when the electronic device in the normal mode (e.g., room temp) operates in the limiting control mode (i.e., the #2 frequency optimization) that reduces the maximum operating frequency of the controller, it may be seen that the power consumption of the controller is reduced by 170 mW and the final temperature Tj is reduced by 2 degrees compared to the non-limiting control mode (#1 Default).

When the electronic device in an emergency control mode (e.g., high temp) operates in the limiting control mode (i.e., the #2 frequency optimization) that reduces the maximum operating frequency of the controller, it may be seen that the power consumption of the controller is reduced by 80 mW and the final temperature Tj is reduced by 2 degrees compared to the non-limiting control mode (#1 Default).

In some embodiments, the electronic device may operate in the limiting control mode while operating in the emergency control mode by reducing a voltage value or a current value supplied to a controller included in the electronic device.

In the case of a high temperature, because one of the parts vulnerable to stability is a volatile memory such as a cache or DRAM included in a controller, the electronic device may reduce the temperature of a semiconductor chip or integrated circuit by adjusting the number of controllers accessing the volatile memory.

That is, the electronic device may cut off power to controllers other than essential controllers. This cut off of power may be referred to as a hotplug operation. In an embodiment, the electronic device may further include a memory that stores data related to a specific operation such that the data related to the specific operation is used by a controller included in the electronic device to perform the specific operation, and the controller may further include a plurality of sub-controllers related to the specific operation to perform the specific operation.

The electronic device may operate in a limiting control mode while operating in an emergency control mode by reducing the number of sub-controllers controllers that may access the memory. In some embodiments, the electronic device may operate in a limiting control mode while operating in an emergency control mode by minimizing a debugging level of the controller included in the electronic device.

In some embodiments, the minimizing of the debugging level may denote minimizing a debugging frequency. For example, a frequency of the debugging start-point may be reduced or a command unit related to the debugging start-point may be increased.

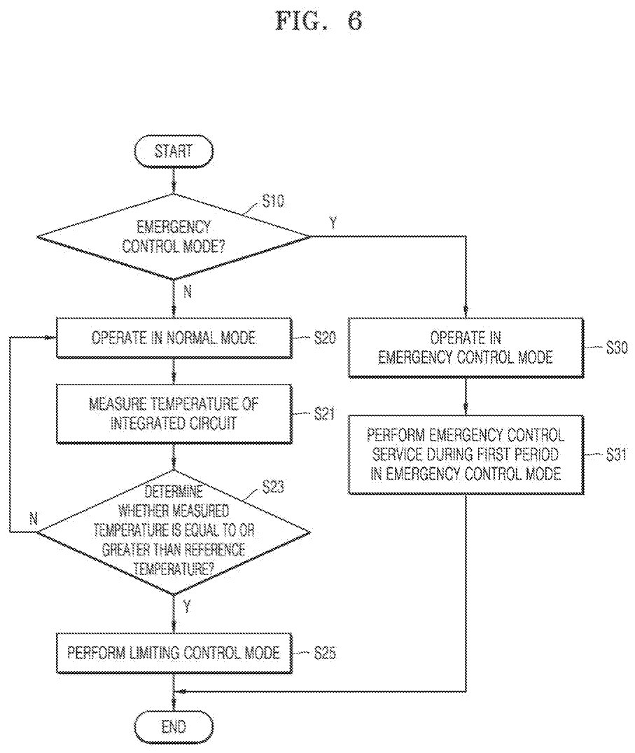

FIG. 6 is a flowchart illustrating the overall operation of an electronic device according to an embodiment.

Referring to FIG. 6, in operation S10, the electronic device may determine whether a current operation mode is an emergency control mode or not.

In an embodiment, the electronic device may operate in one of an emergency control mode and a normal mode based on an emergency call service request.

For example, when the electronic device receives an emergency call service request, the electronic device may operate in an emergency control mode. When the electronic device does not receive an emergency call service request, the electronic device may operate in a normal mode.

When the current operation mode is not an emergency control mode (S10, N), the electronic device may operate in the normal mode in operation S20.

In operation S21, the electronic device may periodically measure a temperature of an integrated circuit included in the electronic device.

In an embodiment, the electronic device may monitor the measured temperature or control the operation of the integrated circuit according to the temperature.

In some embodiments, the electronic device may monitor the temperature of a controller, communication module, or other components included in the electronic device by using a temperature measurement value input from a temperature sensor.

In operation S23, the electronic device may determine whether the measured temperature is equal to or greater than a reference temperature. For example, the electronic device may determine whether the measured temperature is equal to or greater than a third reference temperature

In some embodiments, the third reference temperature may be lower than the first reference temperature described with reference to FIGS. 3 and 4.

When the measure temperature is equal to or greater than the reference temperature (S23, Y), the electronic device may perform a limiting control mode in operation S25.

The electronic device may limit the performance of components included in the electronic device in the limiting control mode. For example, the electronic device may reduce a voltage value or a current value supplied to a component or reduce an operating frequency of a processor included in the electronic device to limit performance. The electronic device may maintain operation in the normal mode when the measured temperature is less than the third reference temperature.

When the current operation mode is the emergency control mode (S10, Y), the electronic device may operate in an emergency control mode in operation S30.

Operations performed by the electronic device in the emergency control mode may have higher priority than other operations of the electronic device. For example, operations additionally performed by the electronic device in the emergency control mode may have a higher priority than operations performed by the electronic device outside the emergency control mode.

That is, the emergency control mode may refer to a mode in which the electronic device prioritizes the emergency call service without being disturbed by anything other than the emergency call service when performing the emergency call service.

In operation S31, the electronic device may perform an emergency call service during a first period in the emergency control mode.

According to embodiments, the electronic device may perform an emergency call for a predetermined time without performing a throttling operation that limits performance even when the temperature of an integrated circuit included in the electronic device exceeds a threshold temperature in the emergency control mode.

However, according to various embodiments, the operation time of the emergency control mode may be extended by performing a temperature control operation while the electronic device is operating in an emergency control mode.

In other words, the operating time of the electronic device may be limited in a high-temperature environment. According to an embodiment, by performing a temperature control operation during operation in an emergency control mode, even in a high-temperature environment, it is possible to maximize the operating time of the emergency control mode, thereby maximizing the provision time of the emergency call service of the electronic device. In operation S31, the electronic device may perform a temperature control operation during operation in an emergency control mode.

In some embodiments, operation S31 may correspond to operation S130 described with reference to FIG. 3.

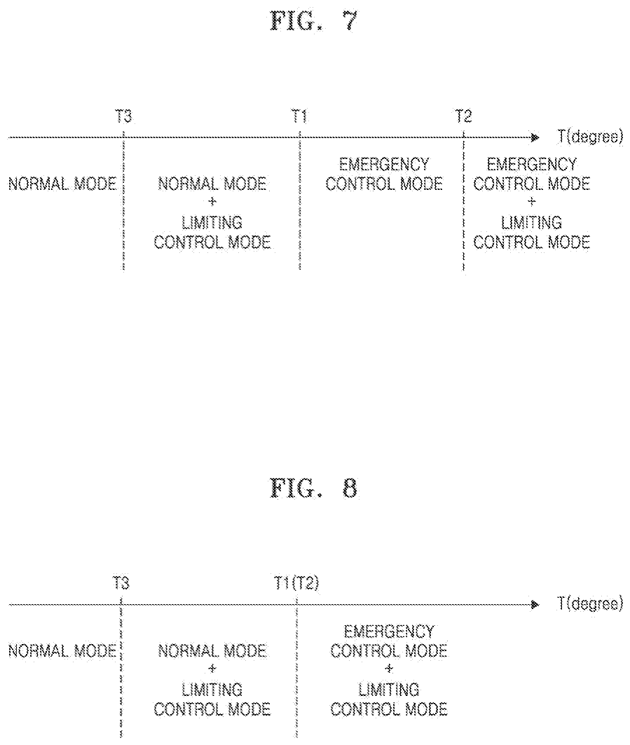

FIG. 7 is a diagram illustrating an example of control of an electronic device according to an embodiment.

FIG. 8 is a diagram illustrating an example of control an electronic device according to an embodiment. FIGS. 7 and 8 are diagrams illustrating an operating mode of an electronic device based on temperature according to an embodiment.

Referring to FIGS. 7 and 8, it may be seen that the operation mode of the electronic device is illustrated based on the first reference temperature T1, the second reference temperature T2, and the third reference temperature T3. The electronic device may operate in the corresponding mode shown in FIGS. 7 and 8 by comparing a temperature of the measurement target measured by the temperature sensor with the first, second, and third reference temperatures T1, T2, and T3.

In some embodiments, for example, the measurement target may be a semiconductor chip or an integrated circuit included in the electronic device and performing a specific operation. The first reference temperature T1 may be a temperature for determining the normal mode of the electronic device and the emergency control mode of the electronic device.

For example, in some embodiments, the first reference temperature T1 may be a maximum value (e.g., 105 degrees) among guaranteed temperatures that guarantee the life of the semiconductor chip. That is, when the temperature of the measurement target rises to be equal to or greater than the first reference temperature T1, the electronic device may operate by changing from a normal mode to an emergency control mode, and when the temperature of the measurement target decreases to be less than the first reference temperature T1, the electronic device may operate by changing the emergency control mode to the normal mode. In some embodiments, the second reference temperature T2 may be a temperature for determining whether or not to perform the limiting control mode of the electronic device in the emergency control mode.

In some embodiments, the third reference temperature T3 may be a temperature for determining whether or not to perform the limiting control mode of the electronic device in the normal mode.

In some embodiments, the first reference temperature T1, the second reference temperature T2, and the third reference temperature T3 may correspond to the first reference temperature, the second reference temperature, and the third reference temperature described with reference to FIGS. 3 to 6, respectively.

Referring to FIG. 7, it may be seen that temperature values are set to increase in the order of the third reference temperature T3, the first reference temperature T1, and the second reference temperature T2.

When the temperature of the measurement target is less than the third reference temperature T3, the electronic device may operate in a normal mode.

That is, when the temperature of the measurement target is less than the third reference temperature T3, the electronic device may provide a telematics function by operating in a normal mode. When the temperature of the measurement target is greater than or equal to the third reference temperature T3 and less than the first reference temperature, the electronic device may operate in the limiting control mode while operating in the normal mode.

That is, when the temperature of the measurement target is greater than or equal to the third reference temperature T3 and less than the first reference temperature, the electronic device may provide a telematics function by operating in the normal mode while operating in the limiting control mode. When the temperature of the measurement target is greater than the first reference temperature T1 and less than the second reference temperature T2, the electronic device may operate in an emergency control mode.

That is, when the temperature of the measurement target is greater than the first reference temperature T1 and less than the second reference temperature T2, the electronic device may provide an emergency call service while operating in an emergency control mode. When the temperature of the measurement target is equal to or greater than the second reference temperature T2, the electronic device may operate in the emergency control mode and in the limiting control mode.

That is, when the temperature of the measurement target is equal to or greater than the second reference temperature T2, the electronic device may provide an emergency call service by operating in the limiting control mode while in the emergency control mode. According to some embodiments, by performing a temperature control operation during operation in an emergency control mode, the operation time of the emergency control mode may be maximized even in a high-temperature environment, thereby maximizing the provision time of the emergency call service of the electronic device.

Referring to FIG. 8, it may be seen that, in some embodiments, the first reference temperature T1 may be greater than the third reference temperature T3 and the first reference temperature T1 and the second reference temperature T2 may be set to the same value.

That is, when the electronic device operates in an emergency control mode, the electronic device may operate in a limiting control mode among the emergency control modes regardless of the temperature thereof. When the temperature of the measurement target is less than the third reference temperature T3, the electronic device may operate in a normal mode.

That is, when the temperature of the measurement target is less than the third reference temperature T3, the electronic device may provide a telematics function by operating in a normal mode. When the temperature of the measurement target is greater than or equal to the third reference temperature T3 and less than the first reference temperature, the electronic device may operate in the limit control mode while operating in the normal mode.

That is, when the temperature of the measurement target is greater than or equal to the third reference temperature T3 and less than the first reference temperature T1, the electronic device may provide a telematics function by operating in the normal mode while operating in the limiting control mode. When the temperature of the measurement target is equal to or greater than the first reference temperature T1, the electronic device may operate in an emergency control mode.

When the electronic device operates in the emergency control mode, the electronic device may operate in the limiting control mode among the emergency control mode regardless of the temperature. That is, when the electronic device operates in the emergency control mode, the electronic device may provide an emergency call service regardless of the temperature thereof by operating in the limiting control mode among the emergency control modes.

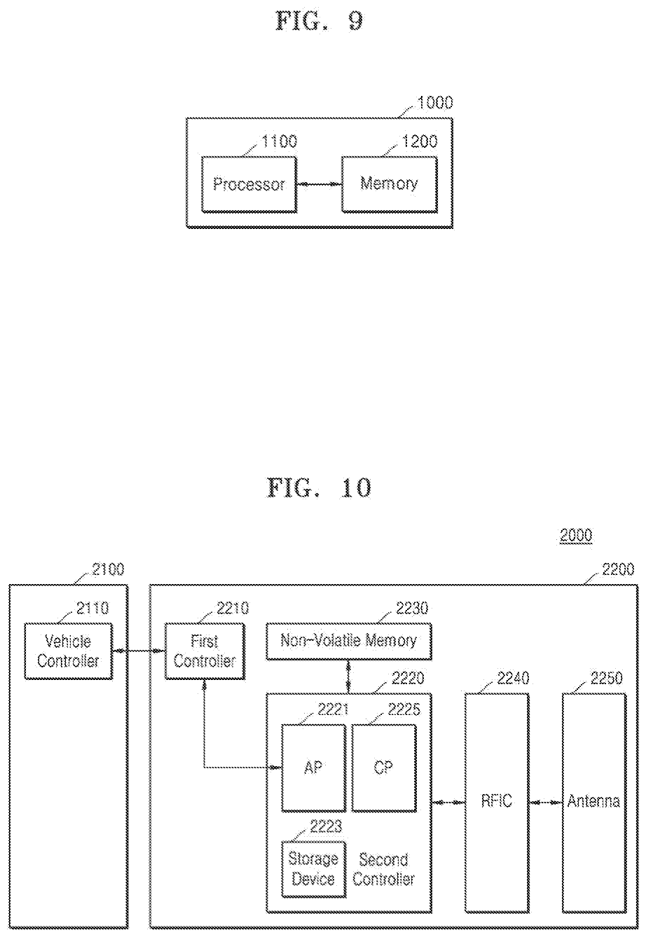

FIG. 9 is a diagram illustrating an example of an electronic device 1000 according to an embodiment.

Referring to FIG. 9, the electronic device 1000 may include a processor 1100 and a memory 1200.

Although in FIG. 9, one processor 1100 is illustrated, embodiments are not limited thereto and, in some embodiments, the electronic device 1000 may include a plurality of processors. In some embodiments, the processor 1100 may include one or more cores (not shown) and a graphics processing unit (not shown) and/or a connection path (e.g., a bus) for transmitting and receiving signals to and from other components.

The processor 1100 may perform the operations of the electronic device described above with reference to FIGS. 1 to 8, for example, in the emergency control mode and in the normal mode.

For example, in some embodiments, the processor 1100 may maximize the operating time of the emergency control mode even in a high-temperature environment by performing a temperature control operation while operating in the emergency control mode, thereby maximizing the provision time of the emergency call service of the electronic device. In some embodiments, the processor 1100 may further include random access memory (RAM, not shown) and read-only memory (ROM, not shown) that temporarily and/or permanently store signals (or data) processed in the processor 1100.

In some embodiments, the processor 1100 may be implemented in the form of a system on chip (SoC) including at least one of a graphics processing unit, RAM, and ROM. The memory 1200 may store programs (one or more instructions) for processing and control of the processor 1100.

In some embodiments, the memory 1200 may include a plurality of modules in which the functions of the controller 130 described with reference to FIG. 1 are implemented. In some embodiments, the memory 1200 may include the memory 140 described with reference to FIG. 1.

FIG. 10 is a diagram illustrating a telematics system 2000 according to an embodiment.

Referring to FIG. 10, the telematics system 2000 may include a vehicle system 2100 and a telematics device 2200.

In some embodiments, the telematics device 2200 may correspond to the electronic device 100 described with reference to FIG. 1, and the telematics device 2200 may be provided in an electronic device, such as a digital still camera, a digital video camera, a smartphone, a wearable device, the IoT device, a tablet PC, a PDA, a PMP, a navigation device, and the like. The vehicle system 2100 may include a vehicle controller 2110.

For example, in some embodiments, the vehicle controller 2110 may be an MCU. The telematics device 2200 may include a first controller 2210 configured to transmit and receive information to and from the vehicle controller 2110 of the vehicle system 2100, a second controller 2220 configured to control the overall operation of the telematics device 2200, a non-volatile memory 2230, an RFIC 2240, and an antenna 2250.

For example, in some embodiments, the first controller 2210 may be an MCU. In some embodiments, the non-volatile memory 2230 may be an MMC storage. In some embodiments, the first controller 2210 may be connected to the vehicle controller 2110 through Ethernet.

In some embodiments, the first controller 2210 may receive an emergency call service request from the vehicle system 2100 or generate an emergency call service request based on information received from the vehicle system 2100. In some embodiments, the first controller 2210 may correspond to the emergency call controller 120 described with reference to FIG. 1. For example, the first controller 2210 may determine whether a vehicle accident has occurred and the severity of the vehicle accident based on information (e.g., information on target outside the vehicle, amount of impact, etc.) received from the sensing device and vehicle information (e.g., vehicle speed signal, vehicle location information, etc.) received from an in-vehicle device through CAN communication, and may generate an emergency call service request.

In some embodiments, when a collision occurs, the first controller 2210 may determine the type of accident target (vehicle, pedestrian, two-wheeled vehicle, etc.), and depending on the type of accident target, the degree of determining the severity of the vehicle accident may be set differently. The second controller 2220 may perform an emergency call service-related operation based on an emergency call service request of the first controller 2210.

In some embodiments, the second controller 2220 may correspond to the controller 130 described with reference to FIG. 1, and operations of the second controller 2220 may correspond to operations of the electronic device described with reference to FIG. 3. The second controller 2220 may be implemented as a system on a chip (SoC), and may include an application processor (AP), a storage device 2223 such as an OTP memory, and a communication processor (CP).

In some embodiments, the communications processor (CP) may correspond to the communication module 150 described with reference to FIG. 1. The second controller 2220 may store information including the number of times the temperature of the measurement target exceeds the first reference temperature and the corresponding temperature of the measurement target when the temperature exceeds the first reference temperature in a memory based on the information about the temperature of the measurement target periodically generated.

In an embodiment, the second controller 2220 may store information including the number of times the temperature of the measurement target exceeds the first reference temperature and the temperature of the measurement target at which the temperature of the measurement target exceeds the reference temperature based on the information on the temperature of the measurement target generated in a cycle of 1 second in the storage device 2223 included inside the controller and the non-volatile memory 2230 mounted outside the second controller 2220, respectively.

Referring to FIG. 10, the storage device 2223 may be an OTP and the non-volatile memory 2230 may be an MMC storage. From the point of view of problem analysis of a SoC, whether or not the electronic device was operated in an extreme temperature may be important information in analysis for quality control.

Therefore, according to various embodiments, by storing information including the number of times the first reference temperature is exceeded and the corresponding temperature of the measurement target at which the corresponding temperature of the measurement target exceeds the first reference temperature, the stored information may be used for later analysis for quality control.

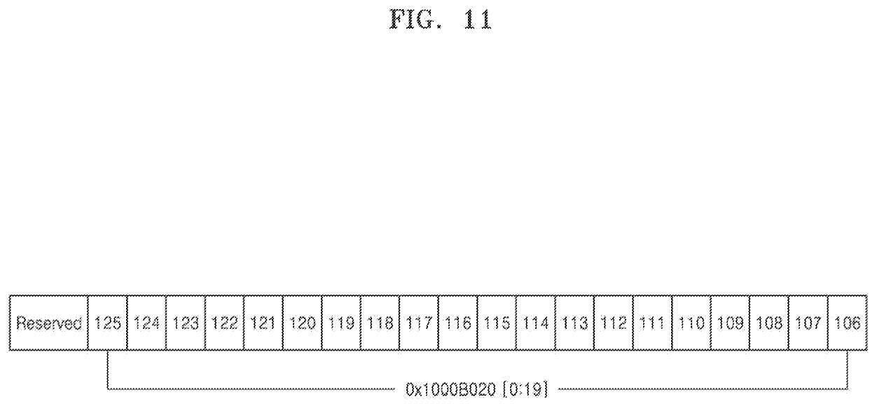

FIG. 11 is a diagram illustrating storage device according to an embodiment.

Referring to FIG. 11, the storage device 2223 may be implemented as an OTP memory and a storage area of the OTP memory described with reference to FIG. 10 is illustrated.

It is explained by assuming that 105 degrees is the highest temperature that may guarantee a chip operation. The storage area of the OTP memory may designate a temperature value for each bit and store the corresponding temperature value in bit units.

Referring to FIG. 11, an expressible temperature range is set to 106 degrees to 125 degrees. Each bit in the storage area of the OTP memory may be displayed as 1 when the telematics device has operated at a corresponding temperature and may be displayed as 0 when the telematics device has never operated at the corresponding temperature.

While various embodiments have been particularly shown and described with reference to the drawings, it will be understood that various changes in form and details may be made therein without departing from the spirit and scope of the following claims.

What is claimed is:

1. An electronic device comprising:
an emergency call controller configured to receive an emergency call service request;
a controller configured to operate the electronic device in one of a normal mode and an emergency control mode based on the emergency call service request;
a temperature sensor configured to measure a temperature of a measurement target; and
at least one memory that stores temperature information about the temperature of the measurement target,
wherein the controller is configured to, when the electronic device is operated in the emergency control mode, perform a temperature control operation based on the temperature information.

2. The electronic device of claim 1, wherein the temperature control operation is performed when the temperature of the measurement target is equal to or greater than a reference temperature.

3. The electronic device of claim 1, wherein the temperature control operation includes controlling a temperature of the electronic device by operating the electronic device in a limiting control mode in which operation of the electronic device is limited compared to operation of the electronic device in a normal control mode.

4. The electronic device of claim 3, wherein the electronic device comprises a memory that stores data related to a specific operation, wherein, in the limiting control mode, the controller reduces a frequency of accessing the memory that stores data related to a specific operation.

5. The electronic device of claim 3, wherein, in the limiting control mode, the controller reduces a maximum operating frequency of the controller.

6. The electronic device of claim 3, wherein, in the limiting control mode, the controller reduces a voltage value or a current value supplied to the controller.

7. The electronic device of claim 3, wherein the at least one memory stores data related to a specific operation, the data being used by to perform the specific operation,
wherein the controller includes a plurality of sub-controllers related to the specific operation, and
in the limiting control mode, the controller reduces a number of sub-controllers that are able to access the data related to the specific operation stored in the at least one memory.

8. A method of operating an electronic device that supports a telematics function for a vehicle, the method comprising:
receiving, by the electronic device, an emergency call service request; and
operating the electronic device in an emergency control mode based on the emergency call service request,
wherein the operating includes performing a temperature control operation while the electronic device operates in the emergency control mode.

9. The method of claim 8, wherein performing the temperature control operation includes:
measuring a temperature of a measurement target; and
performing the temperature control operation while the electronic device operates in the emergency control mode when the temperature of the measurement target is equal to or greater than a reference temperature.

10. The method of claim 8, wherein the temperature control operation includes controlling a temperature of the electronic device by operating the electronic device in a limiting control mode in which operation of the electronic device is limited compared to operation of the electronic device in a normal control mode.

11. The method of claim 10, wherein operating the electronic device in the limiting control mode includes reducing a frequency of access by the electronic device to a memory included in the electronic device.

12. The method of claim 10, wherein operating the electronic device in the limiting control mode includes reducing a maximum operating frequency of a controller included in the electronic device.

13. The method of claim 10, wherein operating the electronic device in the limiting control mode includes reducing a voltage value or a current value supplied to a controller included in the electronic device.

14. The method of claim 10, wherein operating the electronic device in the limiting control mode includes reducing a number of sub-controllers that are able to access a memory included in the electronic device.

15. An electronic device comprising:
at least one processor; and
at least one memory that stores instructions which, when accessed and executed by the at least one processor, cause the at least one processor to perform an operating method comprising:
receiving an emergency call service request; and
operating the electronic device in an emergency control mode based on the emergency call service request,
wherein the operating includes performing a temperature control operation while the electronic device operates in the emergency control mode.

16. The electronic device of claim 15, wherein performing the temperature control operation includes:
measuring a temperature of a measurement target; and
performing the temperature control operation while the electronic device operates in the emergency control mode when the temperature of the measurement target is equal to or greater than a reference temperature.

17. The electronic device of claim 15, wherein the temperature control operation includes controlling a temperature of the electronic device by operating the electronic device in a limiting control mode in which the operation of the electronic device is limited compared to operation of the electronic device in a normal control mode.

18. The electronic device of claim 17, wherein the electronic device comprises a memory that stores data related to a specific operation, and
wherein operating the electronic device in the limiting control mode includes reducing a frequency of accessing, by the electronic device, the memory that stores data related to a specific operation.

19. The electronic device of claim 17, wherein operating the electronic device in the limiting control mode includes reducing a maximum operating frequency of a controller included in the electronic device.

20. The electronic device of claim 17, wherein operating the electronic device in the limiting control mode includes reducing a voltage value or a current value supplied to a controller included in the electronic device.
